(19) United States
(12) Patent Application Publication
(10) Pub. No.: US 2011/0286380 A1
(43) Pub. Date: Nov. 24, 2011

(54) Wireless workgroup bridge for network viryualization

(76) Inventor: Yee Yi Zhu, Shanghai (CN)

(21) Appl. No.: 12/800,765

(22) Filed: May 21, 2010

(51) Int. Cl. H04L 12/56; H04B 7/14

(52) U.S. Cl. 370/315; 370/401

(57) ABSTRACT

A method and device are described for wireless network virtualization, having a workgroup bridge that implements wireless virtual interfaces for virtual machines.

### BACKGROUND

Virtual machines (VM) allow the ability to run multiple operating systems (OS) on a single computer or hardware platform. Multiple OS environments can coexist on the same computer, in isolation from one another. VMs can provide advantages of application provisioning, maintenance, high availability, and disaster recovery. There is a transparency to users of VMs, as to the access to hardware, and specifically a computer.

Disadvantages of VMs include the ability of a VM to access hardware indirectly. This becomes apparent, when a VM connects to a wireless network, because for a hardware device (i.e., computer), there is typically one network address directed to the hardware gateway. This then becomes problematic when there are multiple VMs running on the same computer and using the same hardware gateway.

When a VM or multiple VMs connect to a wireless network, such as a wireless local area network (WLAN), network area translation (NAT) can be used. NAT works on open system interconnection (OSI) layer 3, which is the network layer or above. The NAT approach has design drawbacks. For example, users may not be able to that archive true end-to-end connectivity in violation of the core principle of the Internet as laid out of by the Internet Architecture Board. Furthermore, it may be difficult to use the NAT network approach for implementations that use virtual local area networks (VLAN), Internet protocol security (IPSec), or Internet control message protocol (ICMP).

Other current approaches make use of non-standard hardware. For example, implementing a wireless network interface card (NIC) as a wireless bridge, and connecting the NIC to a WLAN managed by another wireless bridge, or access point with proprietary protocols. Because this approach makes use of non-standard hardware and software, interoperability between different hardware (i.e., vendors) can be a problem.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is an illustrative network that implements wireless workgroup bridge(s) for network virtualization.

FIG. 2 is a block diagram of station that implements a proxy station with virtual wireless interfaces.

FIG. 3 is a block diagram of an exemplary station that implements wireless workgroup bridge(s) for network virtualization.

FIG. 4 is a flow chart for implementation wireless workgroup bridge for network virtualization.

### DETAILED DESCRIPTION

### Overview

In an implementation, a group of virtual machines (VM) are connected into a standard wireless area network (WLAN) through a wireless network interface card (NIC). The group of VMs can also be optionally configured into a virtual local area network (VLAN), such that traffic separation among different groups (VMs) is achieved.

The described methods and approach is not dependent on the Internet Protocol or other protocols, such as TCP/UDP (transmission control protocol/user datagram protocol). Therefore, limitations that exist for NAT approaches may be eliminated. Furthermore, the described methods and approach may be is not limited to particular Open System Interconnection (OSI) model layers.

### Illustrative Network

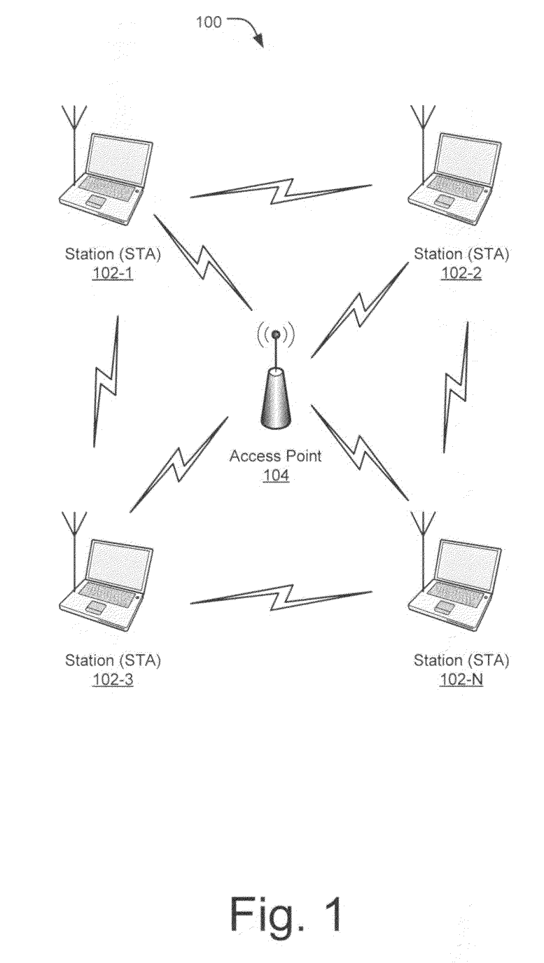

FIG. 1 shows a network 100 that implements wireless workgroup bridge(s) for network virtualization. Network 100 can be one of various wireless networks, including a WLAN, and a VLAN. The network 100 particularly includes multiple stations or STAs 102. In this example, there are STAs 102-1, 102-2, 102-3, and 102-N.

The STAs 102 can communicate directly to one another in Independent Basic Service Set or IBSS mode, or can go through an access point 104 in Basic Service Set or BSS mode. It is to be noted that BSS and IBSS modes cannot be both used at the same time. In particular, the STAs 102 and/or the access point 104 can make use of a wireless NIC acting as a workgroup bridge for network virtualization, as further discussed below.

The STAs 102 include various computing devices, such as laptops, desktops, and other devices. The access point 104 can be part of a computing device, or can be a standalone device. In this example, the STAs 102 and access point 104 can be in wireless communication with one another.

The STAs 102 and/or access point 104 receive and send packets (data messages) between one another; however either the AP 104 is involved in BSS mode, so that all STAs 102 talk to the AP 104, or the AP 104 is not involved and all STAs 102 are working in IBSS mode. The packets include particular media access control (MAC) addresses for particular VMs and actual machines. Therefore, STAs 102 and access point 104 are implemented such that they are able to receive multiple MAC addresses and can distinguish where to forward/send the packets.

### Proxy Station

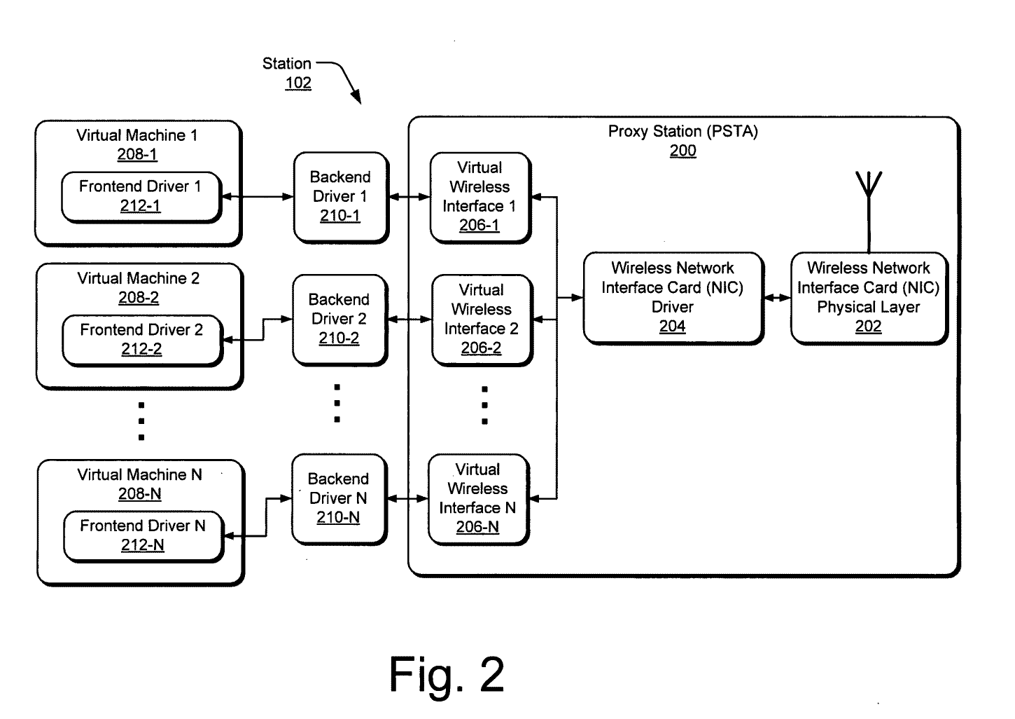

FIG. 2 illustrates an exemplary station 102 that implements a proxy station 200. The proxy station or PSTA 200 performs as a wireless workgroup bridge for network virtualization. In certain implementations, the access point 104 described above, can also implement the PSTA 200.

The PSTA 200 includes a wireless network interface card or NIC 202, which operates at the physical layer (layer 1 of OSI model). The NIC 202 is configured, to be able to filter and recognize particular MAC addresses as discussed above. The MAC addresses are directed to particular VMs or actual machines.

The NIC 202 communicates with a wireless NIC driver 204. The wireless NIC driver 204 can support a certain number of MAC addresses, for example five MAC addresses. The MAC addresses can be automatically or manually changed as needed, and recognized by the NIC driver 204.

The PSTA 200 virtualizes the physical radio (i.e., NIC 202 and NIC driver 204) into a group of virtual wireless interfaces (VWI) 206-1, 206-2, . . . 206-N. Each VWI 206 of the PSTA 200, is a fully functional logical wireless interface having its own unique MAC address (as supported by MAC driver 204). From the perspective of the access point 104 and other STAs 102, each VWI 206 is a “standard” station or STA. In other words, the access point 104 and other STAs 102, recognized the VWI 206 as another STA. Therefore, the PSTA 200 is “transparent” to other STAs 102 and access point 104, and the VWIs 206 are recognized by the STAs 102 and access point 104.

The PSTA 200 can act as local area network (LAN) bridge as to principles of operation. As Ethernet NICs on a LAN, are not aware of a bridge device, the access point 104 and STAs 102, are not aware of the PSTA 200 either. An STA 102 or access point 104 simply believes the VWIs 206 are connected into the network (e.g., network 100) directly. The STAs 102 and access point 104, see the VWIs 206 behind the PSTA 200, directly the same way as the NICs on a LAN, see the other NICs behind a LAN bridge device.

From a VM perspective, the PSTA 200 creates a WI 206 for each Virtual Machine or VM 208 that requires a network connection. In this example, there are N number of Virtual Machines: Virtual Machine 1 208-1, Virtual Machine 2 208-2, . . . , Virtual Machine N 208-N. The creation of a VWI 206 can be performed when a VM 208 is created. In an implementation, virtualization of backend NIC driver 210 converts a VWI 206 into a common virtualization LAN interface, such that the existing VM front end NIC driver 212 can communicate with it without any modification.

Implementation of the PSTA 200 can involve changes/modifications to pre-existing NIC hardware/firmware and driver/kernel software. PSTA 200 should support the following: able to select source MAC addresses from a MAC address list on Transmit (Tx); and select unicast frames from a list of destination MAC addresses and perform acknowledge or ACK, on behalf of each of the MAC address. Software supporting the PSTA 200 should support VWI 206 creation, removal and management. Such software should also allow the MLME or MAC layer management entity, and SME (station management entity) to support software instances running based on each VWI 206. For example, to authenticate and associate with the AP 104 (or STA 102), WiFi Protected Access or WPA, Robust Security Network or RSN, authentication, port access control and key management, and Tx/Rx (transmit/receive), etc., on behalf of each VWI 206.

The PSTA 200 can be called up as a particular mode of operation. As discussed above, in such mode the PSTA 200, virtualizes the wireless PHY radio with multiple virtual wireless interfaces or VWIs 206. The VWIs 206 share most of the physical characteristics (i.e., radio frequency, CTS threshold, etc.) but differ in source MAC addresses. The mode supporting the PSTA 200 can be achieved with relatively minor modifications to existing wireless NIC firmware, to deal with a list of MAC addresses, instead of just one MAC address.

As discussed above, similar hardware can be used or slightly modified to accommodate the PSTA 200. In particular, in the mode that supports the PSTA 200, the same wireless NIC PHY as most of the wireless NICs in the market can be used. It is expected that there are no special requirements for the NIC PHY (e.g., high frequent radio frequencies switching), because all the virtual wireless interfaces work on the same radio frequency as the access point 104 and other STAs 102. The wireless NIC driver 204, which works in the virtualization driver domain, can export the multiple VWIs 206, if the operating system (OS) wireless stack has not already supported it. For example, the “mac80211” wireless stack in 2.6.26 kernel and above supports virtual interfaces. Each virtual interface has its own struct net_device as the kernel network interface representation and this network interface is exported to the user space and configuration tools. All the virtual interfaces associate with the same “wiphy” (wireless PHY) internally. Therefore, for example, a Linux wireless NIC driver does not need any changes on the VWI support.

A slightly modified virtualization backend driver 208, adapts to the virtual wireless interface 206 difference, and communicates to the frontend driver 212, the same way as without the PSTA 200. No changes are expected from the virtual machine side.

### Exemplary Implementation

In an exemplary implementation, a user desires to create a virtual machine VM 208, and have that VM 208 connect to a wireless network (e.g., network 100) in order to access the Internet. Creating the VM 208 ensures that security is provided. For example, a virus running on the VM 208 does not damage the system and hardware. First, the user creates a new VM 208 with a tool, such as Xen xm or Vmware control panel.

The user may be asked if a new network interface through a wireless NIC should be created. The user answers “YES” and can have three options to specify the network MAC address: (1) choose from a factory MAC addresses list (preferred option) (2) let the system generate a random MAC address, or (3) specify a (valid) MAC address.

After this, a virtual wireless interface with the selected MAC address is created automatically and connected with the VM frontend driver 212 with a backend driver 210 in the driver domain. The user can then further configures the virtual wireless interface VWI 206, to associate with the AP (e.g., access point 104 or STA 102), optionally set certain wireless parameters (i.e. CTS threshold, fragmentation threshold, etc) and setup encryption keys. For example, if WiFi Protected Access or WPA is used in Linux, an instance of “wpa_supplicant” tool is running on the VWI 206 to perform authentication and key exchange with the AP or a remote radius server in the driver domain. After this, the VM 208, sees a carrier on (or cable plugged in) LAN interface. The user can then run a dynamic host control protocol or DHCP client tool (e.g., dhclient) to acquire a dynamic IP address, and start accessing the Internet. The VWI 206, can also be deleted/removed, if the interface is no longer required by the VM 208, or with the VM 208 is deleted/removed.

### Exemplary Station

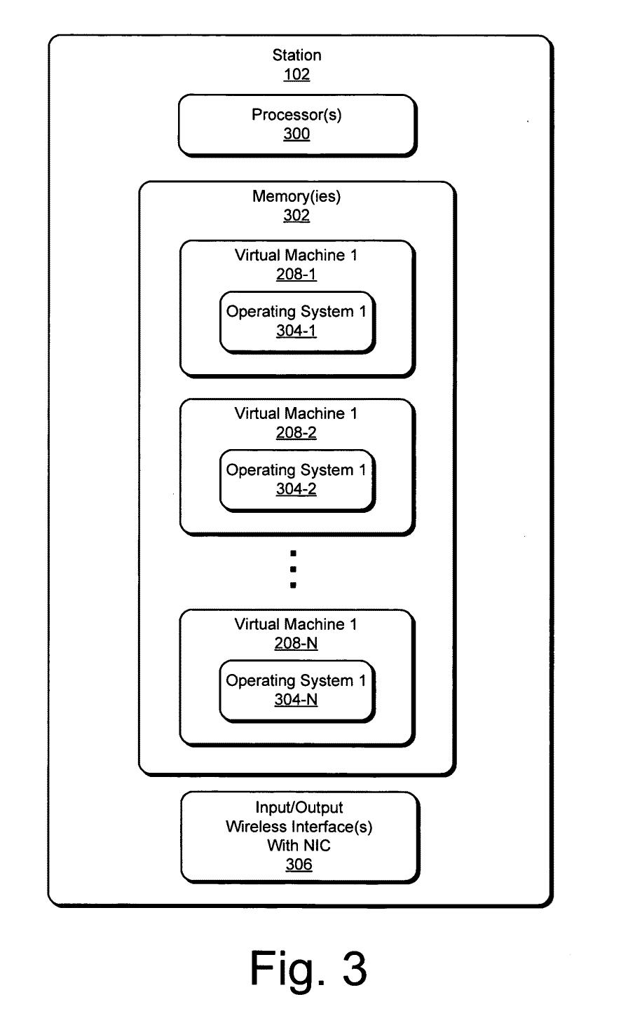

FIG. 3 illustrates an exemplary station or STA 102, that implements wireless workgroup bridge for network virtualization.

The station 102 can be an exemplary embodiment of the previously discussed stations or STAs 102 and in certain implementations, access point 104. As discussed above, station 102 can be one of various wireless computing devices and is part of network (e.g., network 100). The station 102 can communicate with other stations and access points in the network.

Station 102 includes one or more processors 300. The processors 300 are configured to communicate with memory(ies) 302. Memory(ies) 302 can include various types of memory and/or memory devices, including but not limited to random access memory (RAM), read only memory (ROM), internal memory, and external memory. Memory(ies) 302 can furthermore include specific firmware that implement the processes described herein. Memory(ies) 302 can include computer readable instructions operable by station 102. It is to be understood that components described herein, may be integrated or included as part of memory(ies) 302.

In this implementation, memory(ies) 302 includes created virtual machines or VM 208 and the respective operating systems 304. The VMs 208 are described can include frontend drivers 212 connected to backend drivers 210 as discussed above. The memory(ies) 302 may include the backend drivers 210 (not shown) and the virtual wireless interfaces or VWIs 206 (not shown), along with the wireless NIC driver (not shown) as discussed.

The station 102 further can include input/output wireless interfaces 306. The input/output wireless interfaces 306 can include a wireless NIC (e.g., NIC 202) and other hardware radio components. Station 102 can use one or more various wireless input and output interface protocols and standards, such as IEEE 802.11 and its (sub) standards, etc.

### Exemplary Process for Swarm Intelligence

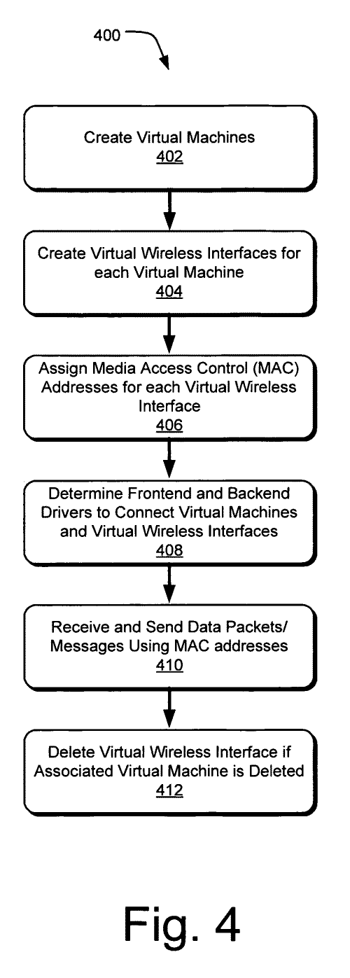

FIG. 4 is a flow chart for an example process 400 for wireless workgroup bridge for network virtualization. As an example, the process 400 may be performed by station 102. The order in which the method is described is not intended to be construed as a limitation, and any number of the described method blocks can be combined to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

At block 402, creating a virtual machine is performed. The virtual machine can be created, as discussed above, by a user through the use of one of several tools, such as a control panel tool that is available through the host computing device. The virtual machine that is created may be one of several virtual machines that are resident on the same computer, and supporting particular/distinct operating systems.

At block 404, creating a virtual wireless interface for each virtual machine is performed. The virtual wireless interface is particular to each virtual machine that is created. As discussed above, the virtual wireless interfaces can be part of a proxy station or PSTA of the host computing device. Each virtual wireless interface can further connect with a wireless NIC driver of the PSTA, where the wireless NIC driver is connected to a wireless NIC (physical layer).

At block 406, assigning media access control (MAC) addresses for each of the virtual wireless interfaces is performed. Each MAC address is unique to each virtual wireless interface, and is “transparent” to stations or devices that desire to communicate to the virtual machine. The MAC addresses can be included in data packets/messages that are communicated by and received by the virtual machines.

At block 408, a determination is made as to backend and frontend drivers to connect the wireless virtual interfaces to the virtual machines. As discussed above, the frontend and backend drivers may be preexisting drivers that are implemented in traditional station configurations. In certain cases, particular and specific frontend and backend drivers are provided to support the connection between the wireless virtual interfaces and virtual machines.

At block 410, receiving and sending of data packets or messages to and from the virtual machines using the unique MAC addresses is performed. The MAC addresses may be encoded into the received and sent data packets and messages. Communication is performed such that each virtual machine acts as a station.

At block 412, deleting the virtual wireless interfaces is performed. A virtual wireless interface is particularly deleted, when its associated virtual machine is deleted, considering there no longer is a need for the particular virtual wireless interface.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic disk storage or other magnetic storage devices, or any other medium which can be used to store the desired information and which can be accessed by a computing device.

What is claimed is:

1. A method implemented by a device to enable a wireless workgroup bridge for network virtualization, comprising:
creating a virtual machine at the device;
creating a virtual wireless interface for the virtual machine, wherein the virtual wireless interface is part of the workgroup bridge;
assigning a unique media access control address to the virtual wireless interface; and
receiving and sending data packets with the unique media access control address.

2. The method of claim 1, wherein the creating the virtual machine initiated by a user.

3. The method of claim 1, wherein the creating the virtual wireless interface includes connecting wireless network interface card driver.

4. The method of claim 1, wherein the assigning the unique media access control address is transparent to other devices.

5. The method of claim 1 further comprising determining frontend and backend drivers to connect the virtual machine to the virtual wireless interface.

6. The method of claim 5, wherein the determining frontend and backend drivers includes using preexisting drivers.

7. The method of claim 1 further comprising deleting the virtual wireless interface if the virtual machine is deleted.

8. The method of claim 1 wherein the virtual machine is one of multiple virtual machines resident at the device.

9. A device to implement a workgroup bridge for network virtualization comprising:
one or more processors; and
a memory coupled to the one or more processors, that comprises:
one or more virtual machines;
virtual wireless interfaces that are particular to each of the one or more virtual machines; and
an input and output wireless interface, that connect the virtual wireless interfaces to a network.

10. The device of claim 9, wherein the memory and input and output interface provide a proxy station for the workgroup bridge.

11. The device of claim 9, wherein the memory includes unique operating systems for each virtual machine.

12. The device of claim 9, wherein the memory includes frontend and backend drivers that connect the virtual wireless interfaces to their respective virtual machines.

13. The device of claim 9, wherein the memory stores unique media access control addresses for each of the virtual wireless interfaces.

14. The device of claim 9, wherein the memory includes a wireless network interface driver that connects to a physical network interface card in the input and output wireless interface.

15. The device of claim 9, wherein the device is a standalone access point.

16. One or more computer-readable storage media storing instructions that, when executed by one or more processors, cause the one or more processors to perform acts comprising:
create a virtual machine;
create a network interface for the virtual machine through a virtual wireless interface that supports the virtual machine; and
assign a media access control address to the virtual machine and virtual wireless interface.

17. The one or more computer-readable storage media of claim 16, wherein the virtual machine is one of several residing on a device.

18. The one or more computer-readable storage media of claim 16, wherein the virtual machine is created by user initiation.

19. The one or more computer-readable storage media of claim 16, wherein the media access control address is chosen from a list of addresses; created randomly; or user defined.

20. The one or more computer-readable storage media of claim 16 further comprising the act of linking frontend and backend drivers to the virtual machine and virtual wireless interface.
